(19) United States
(12) Patent Application Publication
(10) Pub. No.: US 2026/0298397 A1
(43) Pub. Date: Oct. 1, 2026

(54) DRAINAGE STRUCTURE FOR A FRAME FOR ENGINE-DRIVEN WORK MACHINERY

(71) Applicant: AIRMAN CORPORATION, Niigata (JP)

(72) Inventor: Yuta ENDO, Niigata (JP)

(21) Appl. No.: 19/573,973

(22) Filed: Mar. 20, 2026

(30) Foreign Application Priority Data
Mar. 26, 2025 (JP) 2025/051894

(51) Int. Cl. F16M 1/00

(52) U.S. Cl. CPC F16M 1/00; F16M 2200/00

(57) ABSTRACT

A drainage structure for a frame of engine-driven work machinery including: an undercover that covers a bottom surface of a frame from below and is mounted in contact with a lower surface of a frame body; and a frame bottom plate that is arranged above the lower surface of the frame body on the frame body and has an opening portion on a center side, wherein the undercover includes a drain groove, wherein a gap formed between the undercover and the frame bottom plate communicates with an interior of an enclosure only via the opening portion and communicates with an exterior of the machinery only via a drain port that is formed between the drain groove and the lower surface of the frame body, and wherein the undercover includes an inclined structure, thereby causing the drain groove to be inclined downward toward the drain port.

### TECHNICAL FIELD

The present disclosure relates, for package-type engine-driven work machinery, to a drainage structure for a frame that discharges rainwater or the like that has seeped into an interior of the machinery to an exterior thereof.

### BACKGROUND ART

Engine-driven work machinery that has an engine and a machinery body including a generator body, a compressor body, or the like driven by the engine is packaged with components of the engine-driven work machinery housed inside a soundproof box configured, for example, with a frame that serves as a platform to mount the components and an enclosure that covers an upper portion of the frame and is widely used for outdoor work or the like at construction sites or the like due to its portability.

Installing such engine-driven work machinery outdoors under rainy conditions allows rainwater to seep into an interior of the machinery via, for example, an air intake port, a vent port, or the like that is formed on the enclosure of the soundproof box. Here, since the rainwater that has seeped in is usually to be received by the frame positioned below, a drainage structure that allows the frame to drain the rainwater to an exterior of the machinery is desirable to be provided.

Therefore, as a prior art example, as shown in FIG. 15, for the engine-driven work machinery 100 packaged in the soundproof box 101 configured with the frame 102 that serves as the platform to mount the components and the enclosure 103 that covers the upper portion of the frame 102, the drainage structure for the frame in which a drain port (water drain hole) 110 communicating with the exterior of the machinery is provided on an upper surface 102a of the frame 102 is adopted to discharge the rainwater that has seeped into the interior of the machinery to the exterior thereof.

As another prior art example, as shown in FIG. 16, for the engine-driven work machinery 200 including the frame 210 and a box-shaped soundproof case 220 that covers the entire set of the engine, generator, and the like placed on the frame 210, the drainage structure for the frame in which the frame 210 is configured with a pair of channel members 211 and 211 and two support members 212 and 212 that span between the pair of channel members 211 and 211, a first floor plate 214 is mounted on a lower surface of the support members 212 and 212, and further, a second floor plate 216 is provided below the first floor plate 214, and a plurality of drain ports 218, 218, . . . for discharging the rainwater are provided on the first floor plate 214 and the second floor plate 216 to discharge water that has seeped into the machinery from, for example, the vent port 222 to the exterior of the machinery via the drain ports 218, 218, . . . is adopted (Patent Document 1).

Furthermore, as another conventional example, for the engine-driven work machinery 300 including a rectangular parallelepiped-shaped housing 310 that houses the engine, the machinery body to be driven by the engine, and the like, the structure in which an environmental base (machinery platform for environment) 320 that serves as a platform and an inside of which functions as a storage tank for storing leakage fluids from the engine or the like with an opening formed on a part of its upper surface connected to the housing 310 is mounted on a lower portion of the housing 310, and a water receiving plate, which is not shown in the figure, that receives the rainwater seeping in from the vent port, which is not shown in the figure, above the environmental base 320 and a drain port, which is not shown in the figure, that discharges the water received by the water receiving plate to the exterior of the machinery are provided on a side surface of the housing 310 to discharge the rainwater or the like that has seeped into the housing 310 to the exterior of the machinery before it flows into the environmental base 320 is adopted (Patent Document 2).

Note that, as described above, although the engine-driven work machinery 300 in Patent Document 2 does not include a configuration in which the drain port, in other words, the drainage structure, is provided on the environmental base (machinery platform for environment) 320 that corresponds to the frame supporting the engine and the like, the environmental base (machinery platform for environment) 320 described above is, as shown in FIG. 17, configured such that its bottom surface 320a is formed to be inclined downward toward a drain pipe 322 side in longitudinal and width directions (an inclination angle θ in the longitudinal direction and the inclination angle α in the width direction are formed) to efficiently discharge the leakage fluids described above via the drain pipe 322.

### PRIOR ART DOCUMENTS

### Patent Documents

[Patent Document 1] Japanese Utility Model Publication No. 1990-90335.
[Patent Document 2] Japanese Patent Publication No. 2008-298035.

### PROBLEMS TO BE SOLVED BY INVENTION

As described above, the drainage structures for a frame in which, by providing the drain port communicating with the exterior of the machinery on the frame, the water that has seeped into the interior of the machinery is discharged via the drain port have been proposed.

However, in the structure in which the drain port 110 is provided on the upper surface of the frame 102, similarly to the engine-driven work machinery 100 shown in FIG. 15, an operation of a cooling fan installed inside the soundproof box 101, for example, generates negative pressure inside the machinery, causing the water accumulated in a lower portion of the engine-driven work machinery 100 to be drawn to the interior of the machinery via the drain port 110 and then blown up inside the machinery (see the arrow lines in an enlarged view in FIG. 15), resulting in a problem of electrical components or piping parts arranged around the drain port 110 becoming wet and thus causing electrical leakage or corrosion.

In contrast, the engine-driven work machinery 200 in Patent Document 1 in which a space 217 is formed between the first floor plate 214 and the second floor plate 216, and the drain ports 218 provided on the first floor plate 214 mounted to the frame 210 and the drain ports 218 provided on the second floor plate 216 are formed with a horizontal position offset creates resistance to air flowing in via the drain ports 218 due to negative pressure inside the soundproof case 220, preventing water from seeping into the soundproof case 220 from the lower portion of the engine-driven work machinery 200 via the drain ports 218. However, installing the first floor plate 214 and the second floor plate 216 horizontally poses a problem of difficulty in discharging water due to an inability to efficiently guide the water accumulated on the first floor plate 214 or the second floor plate 216 to the drain ports 218, 218, . . .

Regarding this point, it is conceivable to provide an inclination that guides water to the drain ports to enhance drainage with reference to the structure of the bottom surface 320a of the environmental base (machinery platform for environment) of the engine-driven work machinery 300 in Patent Document 2. However, this poses problems in terms of effort and cost for a process to provide the inclination and a positioning thereof.

Therefore, in light of the problems described above, the purpose of the present disclosure is, for package-type engine-driven work machinery, to provide a drainage structure for a frame of engine-driven work machinery that can efficiently discharge rainwater that has seeped into an interior of the machinery to an exterior thereof and can prevent water from seeping into the interior of the machinery via a drain port from a lower portion of the engine-driven work machinery.

### SUMMARY OF THE INVENTION

In one aspect, the disclosed technology provides a drainage structure for a frame of engine-driven work machinery.

The machinery includes an engine and a machinery body and is packaged by the frame and an enclosure.

The frame supports components including the engine and the machinery body, and the enclosure covers an upper side of the frame.

The drainage structure includes an undercover that covers a bottom surface of the frame from below and is mounted in contact with a lower surface of a frame body, with an upper surface of a peripheral end portion serving as an outer periphery of the frame.

The drainage structure further includes a frame bottom plate arranged above the lower surface of the frame body and having an opening portion on a center side.

The undercover includes at least one drain groove extending from the center side toward an edge on its upper surface.

A gap is formed between the undercover and the frame bottom plate.

The gap communicates with a space inside the enclosure only through the opening portion and communicates with an exterior of the machinery only through a drain port formed between the drain groove and the lower surface of the frame body.

The undercover is positioned close to the frame bottom plate with a clearance on the center side and includes an inclined structure in which a distance to the frame bottom plate increases toward an edge side, thereby causing the drain groove to be inclined downward toward the drain port.

In another aspect, the disclosed technology provides a device in which a side end portion of one cover body to be connected includes a step formed by being bent downward through joggling.

A drain groove is formed between a side end portion of another cover body to be fitted onto the step and an inclined portion that forms the step.

In a further aspect, the disclosed technology provides a device including a flexible undercover.

The undercover and the frame bottom plate are fastened by bolts on the center side with a spacer for inclination adjustment interposed therebetween.

The undercover includes the inclined structure formed by being pressed by the bolts and bent to form a protrusion toward the frame bottom plate.

Additionally, the disclosed technology provides a device including an undercover inclined downward toward the drain groove.

The configuration according to the present disclosure described above enables the engine-driven work machinery including the drainage structure for a frame according to the present disclosure to achieve the following significant effects.

The water that has seeped into the enclosure 40 is received by the frame bottom plate 16, flows into a gap 30 (above the undercover 20) via the opening portion 16a of the frame bottom plate 16, and can be efficiently discharged to the exterior of the machinery by being guided from the drain groove 26 on the undercover 20 to the drain port 27.

With the lower portion of the frame 10 covered by the undercover 20, water seepage from the lower portion of the engine-driven work machinery 1 occurs only via the drain port 27, effectively preventing water seepage from the lower portion of the engine-driven work machinery.

In addition, even if water seeps in via the drain port 27, a distance from the drain port 27 positioned at the edge of the frame body 10a, in other words, the frame 10, to the opening portion 16a positioned at the center side of the frame 10 and the inclination that the drain groove 26 has prevent the water that has seeped in via the drain port 27 from easily reaching the opening portion 16 and thus prevent water from being drawn into the opening portion 16a even if negative pressure is generated inside the enclosure 40, thereby preventing water from being blown up via the opening portion 16a inside the enclosure 40. Furthermore, even if water seeps in via the drain port 27, the water is easily discharged due to the inclination that the drain groove 26a has.

During inspection of the engine-driven work machinery 1, the undercover 20 can be removed, allowing work to be performed using the opening portion 16a as an inspection port.

In addition, the configuration in which an inclined structure 29 is established by fastening the bolts 56 to the undercover 20 reduces cost and effort required to form the inclination on the undercover 20.

### BRIEF DESCRIPTION OF THE DRAWINGS

FIG. 1 is an overall view of engine-driven work machinery 1 according to a first embodiment of the present invention.

FIG. 2 is a diagram illustrating the engine-driven work machinery 1 in FIG. 1 installed on a container chassis 90.

FIG. 3 is an overall perspective view of a frame 10 and an undercover 20 of the engine-driven work machinery 1 in FIG. 1.

FIG. 4 is a plan view of the frame 10 in FIG. 3.

FIG. 5 is an enlarged view of a central portion of the frame 10 in FIG. 3.

FIG. 6 is a cross-sectional view of the frame 10 in FIG. 5 in a width direction (X-direction).

FIG. 7 is a diagram illustrating a drain groove 26 formed on the undercover 20 in FIG. 3.

FIG. 8 is a diagram illustrating a flow of drainage inside the engine-driven work machinery 1 in FIG. 1.

FIG. 9 is a diagram illustrating a drain port 27 formed in the engine-driven work machinery 1 in FIG. 1.

FIG. 10 is a diagram illustrating the drain groove 26′ formed on the undercover 20 in FIG. 3.

FIG. 11 is a diagram illustrating the drain port 27′ formed in the engine-driven work machinery 1 in FIG. 1.

FIG. 12 is an explanatory diagram illustrating fastening by bolts of the undercover 20 to a frame bottom plate 16 that the engine-driven work machinery 1 in FIG. 1 includes, with (A) showing a state before fastening and (B) showing a state after fastening.

FIG. 13 is a diagram illustrating a position of the bolts 56 according to a second embodiment of the present invention.

FIG. 14 is a diagram illustrating the drain groove 26 according to a third embodiment of the present invention.

FIG. 15 is a diagram illustrating a drainage structure for a frame of conventional engine-driven work machinery 100.

FIG. 16 is a diagram illustrating the drainage structure for a frame of the other conventional engine-driven work machinery 200.

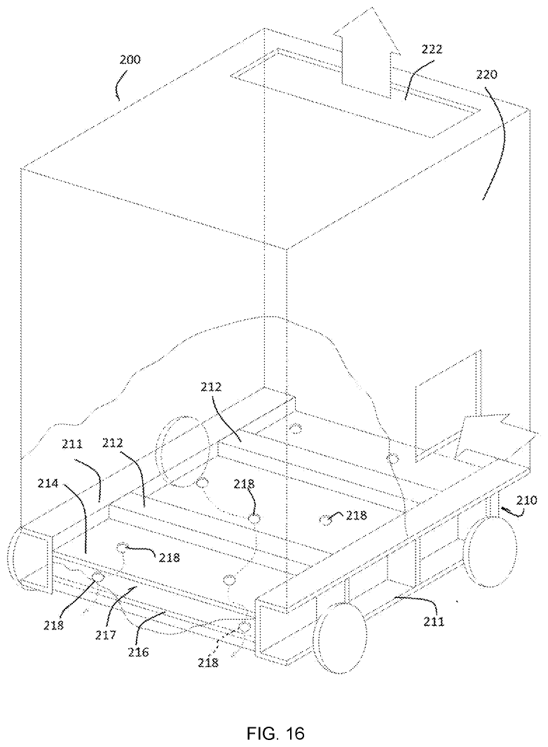

FIG. 17 (a) is a side cross-sectional view of an environmental base 320 that the other conventional engine-driven work machinery 300 includes, and (b) is a front view of the same environmental base 320.

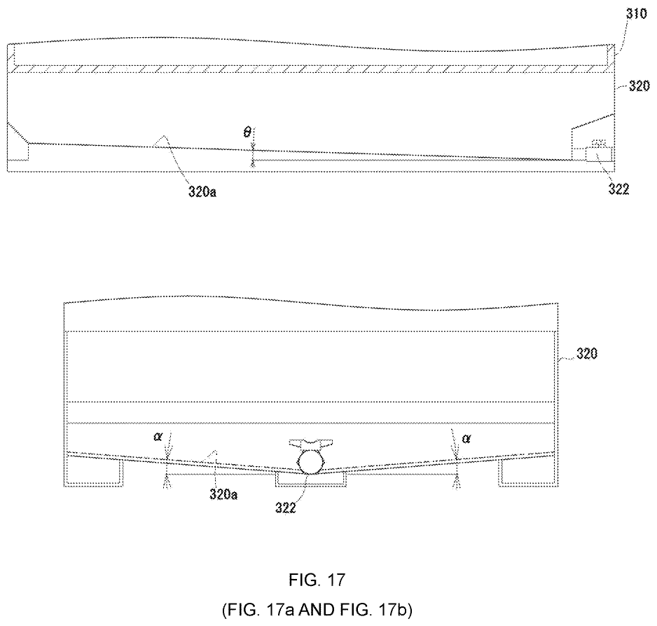

### DESCRIPTION OF EMBODIMENTS

The following describes one embodiment (a first embodiment) of a drainage structure for a frame of engine-driven work machinery according to the present disclosure with reference to the accompanying drawings.

Note that for the sake of explanation, X, Y and Z shown in the figures as appropriate define each direction, with an X direction indicating a width direction, a Y direction indicating a front-to-rear direction and a Z direction indicating a height direction.

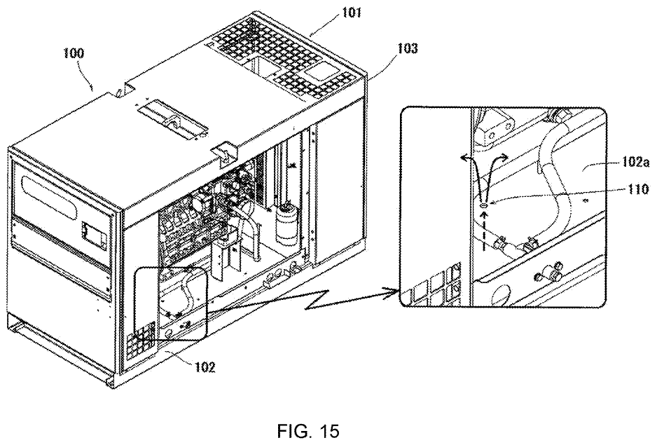

Although the following description explains examples of applying the drainage structure for a frame according to the present disclosure to a generator for a reefer container as the engine-driven work machinery, the drainage structure for a frame according to the present disclosure can also be applied to the engine-driven work machinery with machinery (for example, a compressor) other than a generator mounted thereon and can also be applied to other package-type engine-driven work machinery such as that housed in a soundproof box, as shown in a conventional example in FIG. 15, and its configuration is not limited to the embodiments described below.

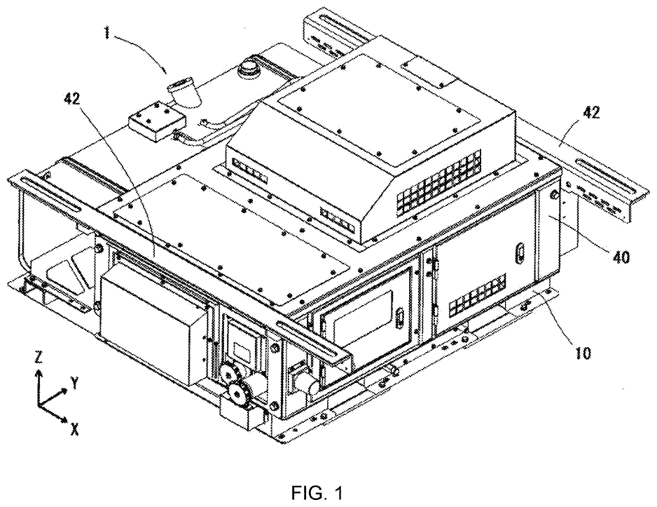

The generator for a reefer container 1 according to the present embodiment (hereinafter referred to as the “engine-driven work machinery 1”), as shown in FIG. 1, includes components composed of an engine, which is not shown in the figure, a generator, which is a machinery body and is not shown in the figure, and other necessary devices, which are not shown in the figure, placed on a frame 10 and is a package in which a box-shaped enclosure 40 including side walls and a top plate covers an upper side of the frame 10.

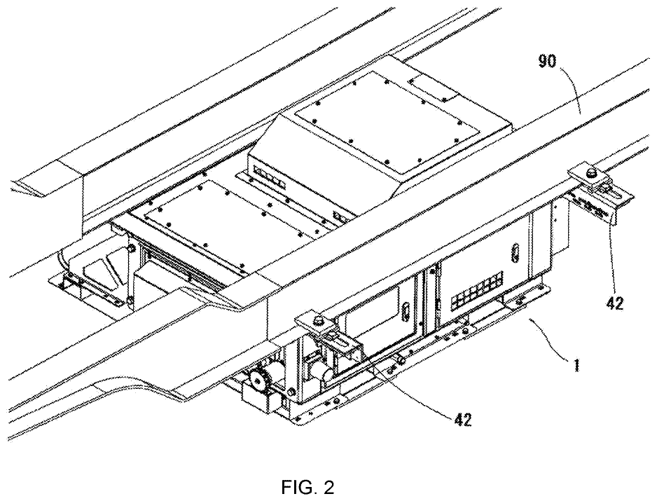

Note that to enable the engine-driven work machinery 1 to be mounted on a container chassis 90 that is towed by a tractor unit, brackets 42 and 42 are provided at an upper portion of end faces on both sides in the front-to-rear direction (Y direction) of the enclosure 40, and as shown in FIG. 2, the engine-driven work machinery 1 can be mounted on the container chassis 90 via the brackets 42 and 42.

The frame 10 described above, on which the engine and the machinery body are placed, has a frame body 10a that serves as an outer periphery of the frame, and the frame body 10a is formed by connecting, for example, channel members or the like.

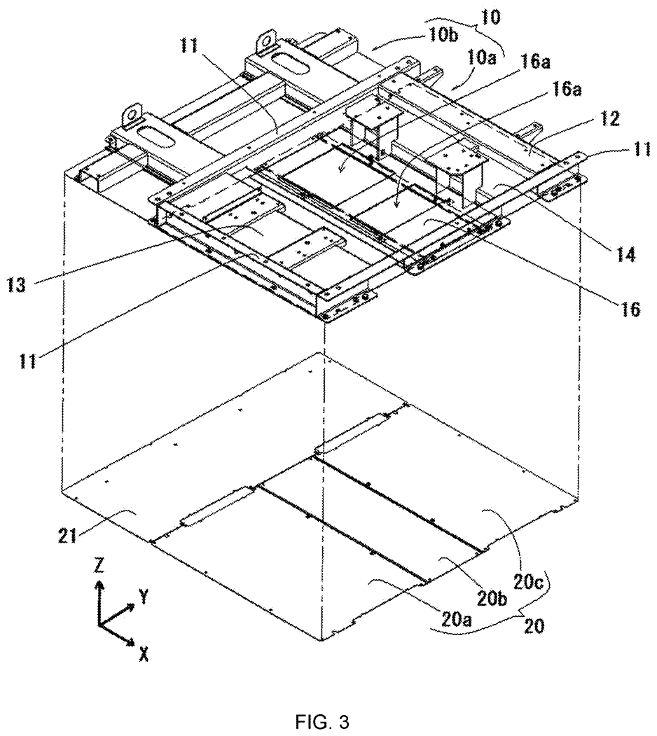

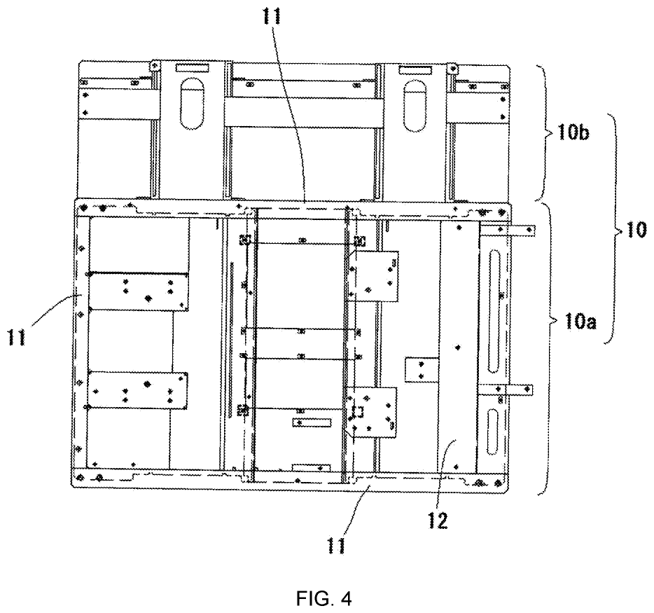

The frame 10 according to the present embodiment, as shown in FIGS. 3 and 4, has the frame body 10a having a rectangular shape in plan view that is formed by surrounding three sides with channel members 11, 11 and 11 and arranging a beam member 12 on the remaining one side. Note that, as shown in FIG. 3, each of the channel members 11, 11 and 11 that configures the frame body 10a according to the present embodiment has a substantially uniform cross-section, and each of the channel members 11, 11 and 11 is arranged to have an outwardly open cross-section.

The frame 10 is configured such that the components composed of the engine, the machinery body, which are not shown in the figure, and the like can be placed thereon by, for example, installing cross members 13 and 14 on the frame body 10a (see FIG. 3).

The frame 10 according to the present disclosure may be configured, similar to the frame 10 according to the present embodiment, such that the frame body 10a described above serves as a main body portion of the frame, and an auxiliary portion 10b is consecutively connected to one side (the upper side of the sheet in FIG. 4) of the frame body (the main body portion) 10a, and, for example, a fuel tank, which is not shown in the figures, may be installed on the auxiliary portion 10b.

Note that although the drainage structure for a frame according to the present disclosure is applied to the frame body (the main body portion) 10a of the frame 10 in the present embodiment, the drainage structure for a frame according to the present disclosure may also be applied to the auxiliary portion 10b of the frame 10.

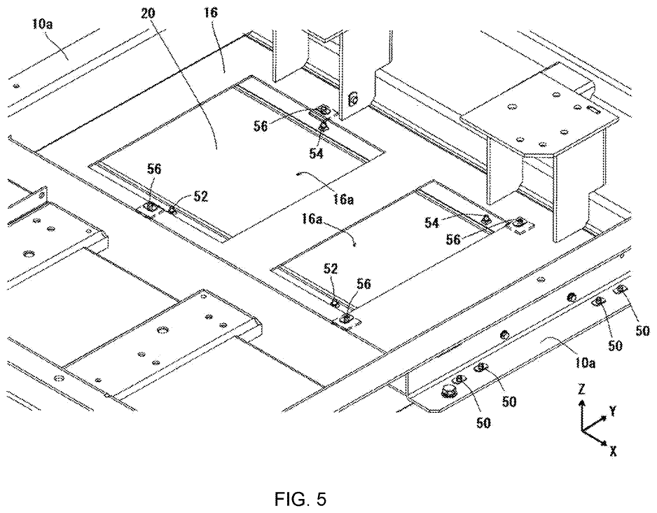

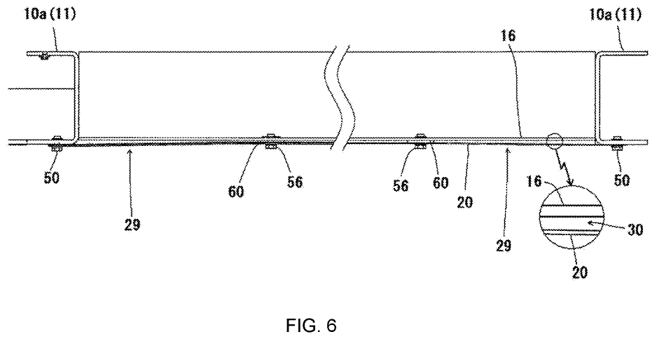

The frame 10 described above has a frame bottom plate 16 that forms a bottom surface of the frame 10, as shown in FIGS. 3 and 5. The frame bottom plate 16 is arranged at a position above a lower surface of the frame body 10a (the channel member 11), specifically, arranged on the frame body 10a to be positioned above an undercover 20 described later (see FIG. 6).

Note that in the present disclosure, although the position of the frame bottom plate 16 in the height direction is merely required to be a position above the lower surface of the frame body 10a with no particular restriction on a height from the lower surface of the frame body 10 a, the frame bottom plate 16 is arranged at a position 4.5 mm above the lower surface of the frame body 10a in the present embodiment.

Installation methods for the frame bottom plate 16 include, for example, mounting it to an inner circumference surface of a vertical wall of the frame body 10a (the channel member 11) by means of, for example, welding or the like but are not particularly limited.

Two rectangular-shaped opening portions 16a and 16a are formed on a center side of the frame bottom plate 16, as shown in FIGS. 3 and 5, thereby enabling the devices installed inside the machinery to be inspected via the opening portions 16a and 16a as inspection ports.

Next, as shown in FIG. 3, the engine-driven work machinery 1 includes a flat plate-shaped undercover 20 that covers the bottom surface of the frame 10 (the bottom surface of the frame body (the main body portion) 10a of the frame 10 in the present embodiment) from below.

The undercover 20 in the present embodiment is composed of three rectangular-shaped cover bodies, as shown in FIG. 3. In the present embodiment, the three cover bodies are referred to as a front portion cover body 20a, a center portion cover body 20b and a rear portion cover body 20c, with the front portion cover body 20a arranged on a front side of the frame body 10a, the center portion cover body 20b arranged at a lower center portion of the frame body 10a while covering the opening portions 16a and 16a of the frame bottom plate 16 from below, and the rear portion cover body 20c arranged on a rear side of the frame body 10a.

The front portion cover body 20a, the center portion cover body 20b and the rear portion cover body 20c described above are detachably connected and integrated into a single body by bolt fastening as described later, and therefore the undercover 20 according to the present embodiment is configured to be separable.

The front portion cover body 20a, the center portion cover body 20b and the rear portion cover body 20c have flexibility, in other words, the undercover 20 is configured to have flexibility.

Note that the engine-driven work machinery 1 according to the present disclosure may further include an auxiliary portion cover body 21 that covers the lower portion of the auxiliary portion 10b of the frame 10, in addition to the undercover 20 described above, as in the present embodiment. Note that in the present embodiment, the auxiliary portion cover body 21 is not connected to the three cover bodies, the front portion cover body 20a, the center portion cover body 20b and the rear portion cover body 20c, described above but is separately mounted to the auxiliary portion 10b of the frame 10.

The undercover 20 described above is mounted by fastening bolts 50 such that an upper surface of its peripheral end portion is in contact with the lower surface of the frame body 10a, as shown in FIGS. 5 and 6.

As a result, a gap 30 is formed between the undercover 20 positioned immediately below the lower surface of the frame body 10a and the frame bottom plate 16 arranged at a position above the lower surface of the frame body 10a (see FIG. 6).

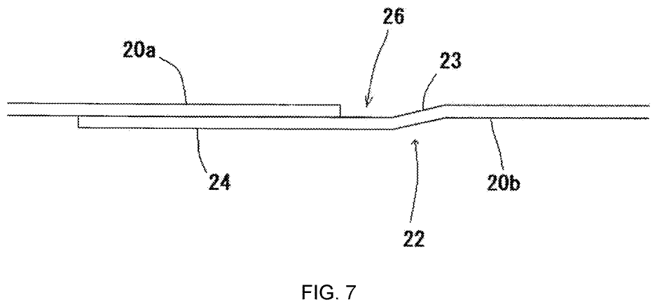

As described above, the front portion cover body 20a and the center portion cover body 20b are connected by bolt fastening. With regard to this connection structure, referring to the portion where a side end portion on the rear side of the front portion cover body 20a and the side end portion on the front side of the center portion cover body 20b are fastened by the bolts 52 (see FIGS. 3 and 5), as shown in FIG. 7, the side end portion on the front side of the center portion cover body 20b has a step 22 formed by being bent downward by an amount corresponding to a thickness of the cover body through joggling and includes an inclined portion 23 and an overlapping portion 24 that form the step 22.

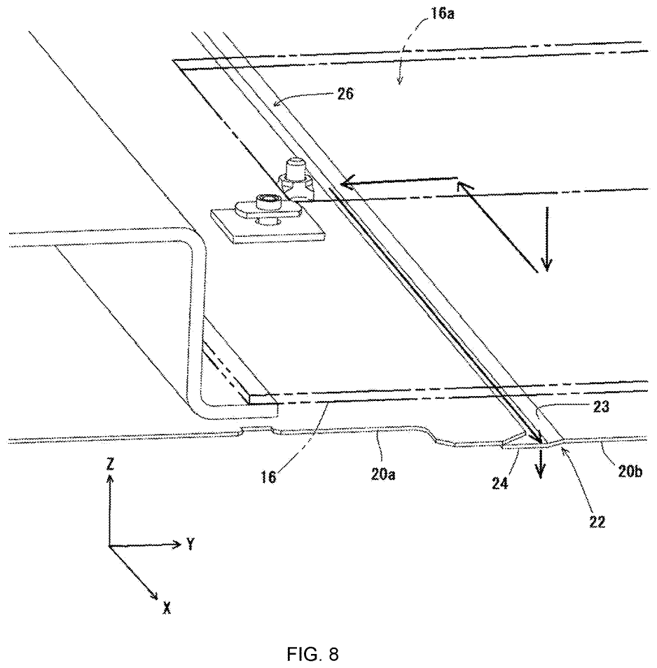

As shown in FIG. 7, fitting the side end portion of the front portion cover body 20a onto the step 22 and fastening the overlapping portion 24 and the side end portion of the front portion cover body 20a with the bolts while they overlap forms a groove (a drain groove) 26 between the inclined portion 23 and the side end portion of the front portion cover body 20a along the width direction (X direction) of the undercover 20 (see FIG. 8). In this manner, the undercover 20 includes the drain groove 26 that extends from the center side toward an edge side (both edge sides in the width direction of the undercover 20 in the present disclosure) on its upper surface.

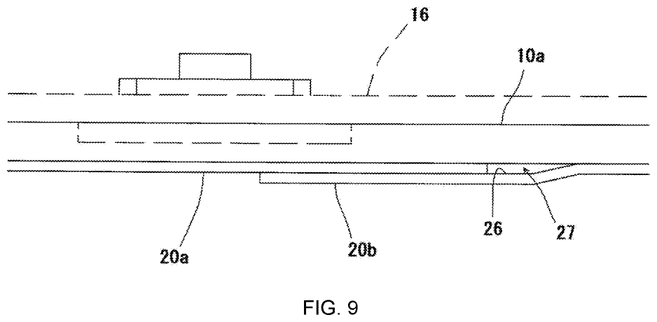

As described above, since the front portion cover body 20a and the center portion cover body 20b are fastened by the bolts to be in contact with the bottom surface of the frame body 10a, the drain port 27 is formed at both edges in the width direction (X direction) of the frame body 10a between the drain groove 26 and the bottom surface of the frame body 10a (see FIG. 9).

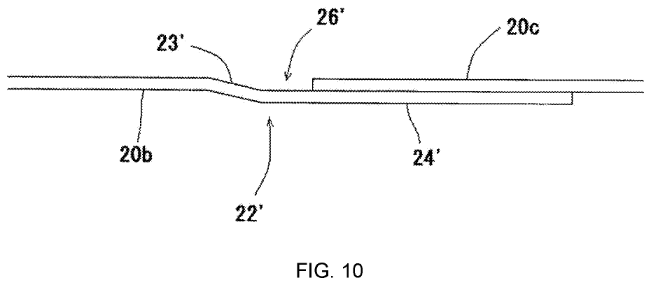

Similarly, the rear portion cover body 20c and the center portion cover body 20b are connected by bolt fastening. With regard to this connection structure, referring to the portion where the side end portion on the front side of the rear portion cover body 20c and the side end portion on the rear side of the center portion cover body 20b are fastened by the bolts 54 (see FIGS. 3 and 5), as shown in FIG. 10, the side end portion on the rear side of the center portion cover body 20b has the step 22′ formed by being bent downward by an amount corresponding to the thickness of the cover body through joggling and includes the inclined portion 23′ and the overlapping portion 24′ that form the step 22′, and fitting the side end portion of the rear portion cover body 20c onto the step 22′ and fastening, while the overlapping portion 24′ and the side end portion of the rear portion cover body 20c overlap, them with the bolts forms the groove (the drain groove) 26′ between the inclined portion 23′ and the side end surface of the rear portion cover body 20c along the width direction of the undercover 20.

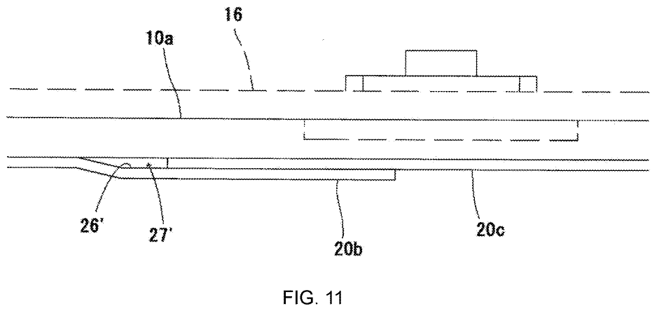

As described above, since the center portion cover body 20b and the rear portion cover body 20c are fastened by the bolts to be in contact with the bottom surface of the frame body 10a, the drain port 27′ is formed at both edges in the width direction (X direction) of the frame body 10a between the drain groove 26′ and the bottom surface of the frame body (see FIG. 11).

According to the configuration described above, the gap 30 formed between the frame bottom plate 16 and the undercover 20 communicates with a space inside the enclosure 40 only via the opening portions 16a and 16a and with an exterior of the machinery only via the drain ports 27 and 27′.

Next, in the present embodiment, the undercover 20 that covers the lower portion of the frame body 10a and the frame bottom plate 16 are configured such that they can be fastened by the bolts 56 with a spacer for inclination adjustment 60 interposed therebetween.

In the present embodiment, the positions of the bolts 56 for fastening the undercover 20 and the frame bottom plate 16 are, as shown in FIG. 5, a total of four locations, two of which are at the center side in the width direction of the side end portion on the rear side of the front portion cover body 20a, and two of which are at the center side in the width direction of the side end portion on the front side of the rear portion cover body 20c.

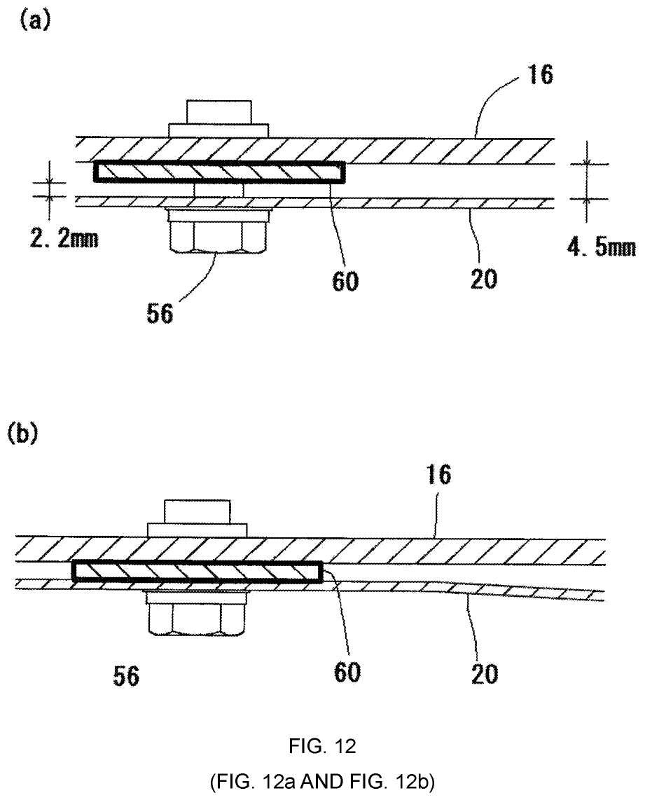

The spacer for inclination adjustment 60 described above has an insertion hole through which a threaded portion of the bolt 56 can pass, is set to have a thickness of 2.3 mm in the present embodiment and is arranged between the undercover 20 and the frame bottom plate 16, as shown in FIGS. 6 and 12.

As shown in FIG. 6, the undercover 20, which has flexibility, when fastened by the bolts, is pressed by the bolts 56 to be bent to form a protrusion toward the side of the frame bottom plate 16, is lifted up from the position of the bottom surface of the frame body 10a on the center side surrounded by the bolts at four locations to be in proximity to the lower surface of the frame bottom plate 16 with the thickness of the spacer for inclination adjustment 60 reserved (via the gap), and forms an inclined structure 29 in which a distance to the frame bottom plate 16 increases toward the edge side, in other words, the side of the frame body 10a.

The inclined structure 29 that the undercover 20 includes causes the drain grooves 26 and 26′ to be inclined downward toward both end sides in the width direction (X direction), in other words, toward the drain ports 27 and 27′.

Note that with regard to the height of an inclination of the inclined structure 29, in the present embodiment, referring to the portion where a spacing of 4.5 mm is formed between the undercover 20 and the frame bottom plate 16 due to the frame bottom plate 16 being arranged at a position 4.5 mm above the lower surface of the frame body 10 a, as shown in FIG. 12(a), before bolt fastening, the inclination with a height difference of 2.2 mm is formed as the undercover 20 is lifted up by 2.2 mm with the thickness of 2.3 mm of the spacer for inclination adjustment 60 reserved, as shown in FIG. 12(b), after bolt fastening.

The engine-driven work machinery 1 according to the present embodiment, which has the configuration described above, has the drainage structure for a frame that receives water that has seeped into the enclosure 40 with the frame bottom plate 16, allows the water to flow into the gap 30 (above the undercover 20) via the opening portion 16a of the frame bottom plate 16, and discharges the water to the exterior of the machinery by guiding the water along the drain groove 26 on the undercover 20 to the drain port 27 (see the arrow lines in FIG. 8).

Although there is a risk that the engine-driven work machinery 1 according to the present embodiment, being mounted to the container chassis 90 while elevated from the ground as described above, is susceptible to water seeping in from below due to water splashing up from puddles on roads during truck travel or the like, the engine-driven work machinery 1 according to the present embodiment, with the lower portion of the frame 10 covered by the undercover 20, which includes the auxiliary portion cover body 21 in the present embodiment, allows water to seep in only via the drain port 27 formed between the drain groove 26 and the lower surface of the frame body 10a, thereby effectively preventing water from seeping in from the lower portion of the engine-driven work machinery.

In addition, as in the present embodiment, the thinner the thickness of the undercover 20, the smaller the inclined portion 23 formed through joggling becomes, and accordingly, the smaller the drain groove 26 becomes, and furthermore, the smaller the drain port 27 formed between the drain groove 26 and the lower surface of the frame body 10a becomes, thereby preventing water from easily seeping in via the drain port 27.

As described above, the undercover 20 and the structure of the drain port 27 in the present embodiment prevent water from seeping into the frame 10 from the lower portion of the engine-driven work machinery 1, thereby preventing corrosion of the frame itself.

In addition, the distance from the drain port 27 positioned at the edge of the frame body 10a, in other words, the frame 10, to the opening portion 16a positioned at the center side of the frame 10 prevents the water that has seeped in from the drain port 27 from easily reaching the space inside the enclosure 40 via the opening portion 16a and thus prevents water from being drawn into the opening portion 16a even if negative pressure is generated inside the enclosure 40, thereby preventing water from being blown up via the opening portion 16a inside the enclosure 40.

Furthermore, the drain groove 26 having the inclination prevents the water that has seeped in via the drain port 27 from easily reaching the opening portion 16a, and even if water seeps in, the inclination enhances drainage.

As described above, the engine-driven work machinery 1 according to the present embodiment has a structure that prevents water from seeping in from below via the drain port 27, as well as a structure that prevents water from reaching inside the enclosure 40 even if water seeps in, thereby preventing corrosion due to contact with water on electrical components or piping parts inside the enclosure.

In addition, when inspecting the engine-driven work machinery 1 according to the present embodiment, work can be performed using the opening portion 16 as the inspection port by removing only the center portion cover body 20b that covers the opening portion 16a of the frame bottom plate 16.

Furthermore, the inclined structure 29 of the undercover 20 is established by fastening the bolt 56, thereby reducing cost and effort required to form the inclination.

Note that in the present invention, the drainage structure for a frame according to the present disclosure may also be applied to the auxiliary portion 10b of the frame 10 according to the present embodiment, and in such a case, the drain groove 26 may be formed on the auxiliary portion cover body 21 to serve as the undercover 20 according to the present invention.

Next, a second embodiment of the drainage structure for a frame of engine-driven work machinery according to the present invention is described.

Note that in the description below, the present embodiment is explained primarily with respect to points different from the first embodiment described above, with similar points omitted. The same reference signs are used to describe the corresponding portions of the first embodiment.

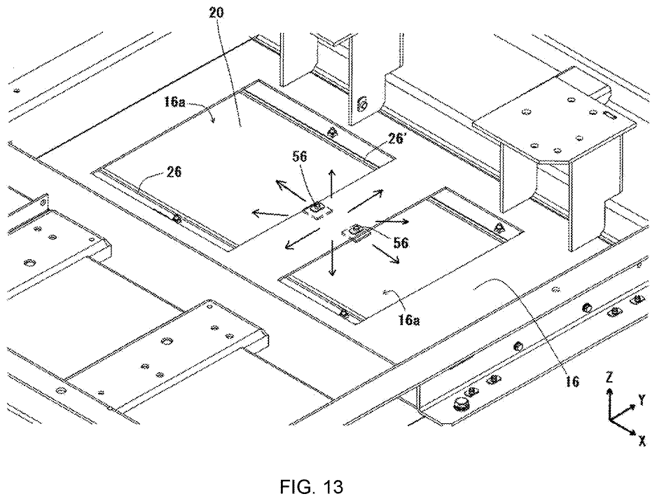

In the present embodiment, the positions of the bolts 56 for fastening the undercover 20 and the frame bottom plate 16 are two locations at the center of the frame bottom plate 16 (between the two opening portions 16a), as shown in FIG. 13.

As a result, compared to the first embodiment, the inclination (the inclined structure 29) formed by the undercover being pressed by fastening the bolts 56 is established further toward the center side, with the inclination being formed concentrically around the bolts 56 (see the arrow lines in FIG. 13).

Therefore, the undercover 20 according to the present embodiment has the inclination descending toward the drain grooves 26 and 26′ and, compared to the first embodiment, enables the water that has seeped in via the opening portion 16a onto the undercover 20 (in other words, into the gap 30) to flow more readily toward the drain groove 26, thereby increasing drainage efficiency.

Next, a third embodiment of the drainage structure for a frame of engine-driven work machinery according to the present invention is described.

Note that in the description below, the present embodiment is explained primarily with respect to points different from the first embodiment described above, with similar points omitted. The same reference signs are used to describe the corresponding portions of the first embodiment.

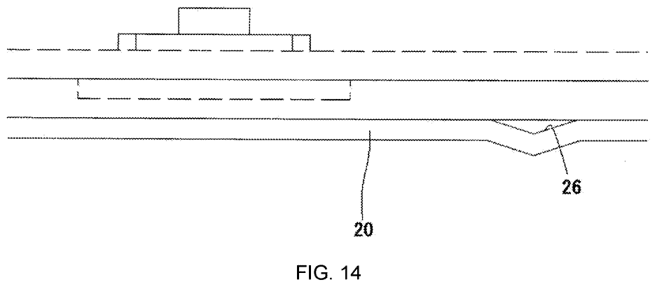

In the present embodiment, the undercover 20 is formed as a single plate body (a cover body), and the drain groove 26 is formed by the undercover 20 being bent (see FIG. 14). Note that methods for forming the drain groove 26 may include machining the upper surface of the undercover 20 and are not particularly limited.

As in the present embodiment, the undercover 20 is not necessarily required to have a separable structure in the present invention.

### Explanation of Reference Signs

1 engine-driven work machinery (generator for reefer container)
10 frame
10a frame body (main body portion)
10b auxiliary portion
11 channel member
12 beam member
13 cross member
14 cross member
16 frame bottom plate
16a opening portion
20 undercover
20a front portion cover body
20b center portion cover body
20c rear portion cover body
21 auxiliary portion cover body
22, 22′ step
23, 23′ inclined portion
24, 24′ overlapping portion
26, 26′ drain groove
27, 27′ drain port
29 inclined structure
30 gap
40 enclosure
42 bracket
50 bolt (for fastening undercover 20 and frame body 10a)
52 bolt (for fastening front portion cover body 20a and center portion cover body 20b)
54 bolt (for fastening rear portion cover body 20c and center portion cover body 20b)
56 bolt (for fastening undercover 20 and frame bottom plate 16)
60 spacer for inclination adjustment
90 container chassis
100 engine-driven work machinery
101 soundproof box
102 frame
102a upper surface
103 enclosure
110 drain port
200 engine-driven work machinery
210 frame
211 channel member
212 support member
214 first floor plate
216 second floor plate
217 space
218 drain port
220 soundproof case
222 vent port
300 engine-driven work machinery
310 housing
320 environmental base (machinery platform for environment)
320a bottom surface
322 drain pipe

1. A drainage structure for a frame of engine-driven work machinery, the engine-driven work machinery including an engine and a machinery body and being packaged by the frame and an enclosure, the frame supporting components including the engine and the machinery body, the enclosure covering an upper side of the frame, the drainage structure for the frame of the engine-driven work machinery comprising:
an undercover that covers a bottom surface of the frame from below and is mounted in contact with a lower surface of a frame body with an upper surface of a peripheral end portion thereof serving as an outer periphery of the frame; and a frame bottom plate that is arranged above the lower surface of the frame body on the frame body and has an opening portion on a center side,
wherein the undercover includes at least one drain groove that extends from the center side to an edge on the upper surface thereof,
wherein a gap is formed between the undercover and the frame bottom plate, and the gap communicates with a space inside the enclosure only via the opening portion and communicates with an exterior of the machinery only via a drain port that is formed between the drain groove and the lower surface of the frame body, and
wherein the undercover is in proximity to the frame bottom plate with a clearance on the center side and includes an inclined structure in which a distance to the frame bottom plate increases toward an edge side, so as to cause the drain groove to be inclined downward toward the drain port.

2. The drainage structure for a frame of engine-driven work machinery according to claim 1,
wherein the undercover is configured with a plurality of cover bodies connected,
wherein a side end portion of one cover body that is to be connected includes a step formed by being bent downward through joggling, and
wherein the drain groove is formed between the side end portion of the other cover body that is to be fitted onto the step and the inclined portion that forms the step.

3. The drainage structure for a frame of engine-driven work machinery according to claim 1,
wherein the undercover has flexibility,
wherein the undercover and the frame bottom plate are fastened by bolts on the center side with a spacer for inclination adjustment interposed therebetween, and
wherein the undercover includes the inclined structure formed by the undercover being pressed by the bolts to be bent to form a protrusion toward a side of the frame bottom plate.

4. The drainage structure for a frame of engine-driven work machinery according to claim 3,
wherein the undercover includes an inclination that descends toward the drain groove.

5. The drainage structure for a frame of engine-driven work machinery according to claim 1,
wherein the undercover has flexibility,
wherein the undercover and the frame bottom plate are fastened by bolts on the center side with a spacer for inclination adjustment interposed therebetween, and
wherein the undercover includes the inclined structure formed by the undercover being pressed by the bolts to be bent to form a protrusion toward a side of the frame bottom plate.

6. The drainage structure for a frame of engine-driven work machinery according to claim 1,
wherein the undercover includes an inclination that descends toward the drain groove.

7. The drainage structure for a frame of engine-driven work machinery according to claim 2,
wherein the undercover includes an inclination that descends toward the drain groove.
